(19) United States
(12) Patent Application Publication
(10) Pub. No.: US 2022/0281112 A1
(43) Pub. Date: Sep. 8, 2022

(54) VIRTUAL REALITY-BASED CAREGIVING MACHINE CONTROL SYSTEM

(71) Applicant: SOUTHEAST UNIVERSITY, Nanjing, Jiangsu (CN)

(72) Inventors: Aiguo SONG, Nanjing, Jiangsu (CN); Chaolong QIN, Nanjing, Jiangsu (CN); Yu ZHAO, Nanjing, Jiangsu (CN); Linhu WEI, Nanjing, Jiangsu (CN); Huijun LI, Nanjing, Jiangsu (CN); Hong ZENG, Nanjing, Jiangsu (CN)

(21) Appl. No.: 17/637,265

(22) PCT Filed: Apr. 21, 2020
(86) PCT No.: PCT/CN2020/085877

§ 371 Date: Feb. 22, 2022

(30) Foreign Application Priority Data
Feb. 24, 2020 (CN) 202010112652.X

(51) Int. Cl. B25J 9/16; B25J 11/00; B25J 13/06; G06F 3/0488; G06F 3/0484; G05B 19/4155

(52) U.S. Cl. CPC B25J 9/1689; B25J 11/009; B25J 13/06; G06F 3/0488; G06F 3/0484; G05B 19/4155; G06F 3/167

(57) ABSTRACT

A virtual reality-based caregiving machine control system includes a visual unit, configured to obtaining environmental information around a caregiving machine, and transmitting the environmental information to a virtual scene generation unit and a calculation unit; the calculation unit, configured to receiving control instructions for the caregiving machine, and obtaining, by calculation according to the environmental information, an action sequence of executing the control instructions by the caregiving machine; the virtual scene generation unit, configured to generating a virtual reality scene from the environmental information, and displaying the virtual reality scene on a touch display screen in combination with the action sequence; and the touch display screen, configured to receiving a touch screen adjusting instruction for the action sequence and feeding back same to the calculation unit for execution, and receiving a confirmation instruction for the action sequence.

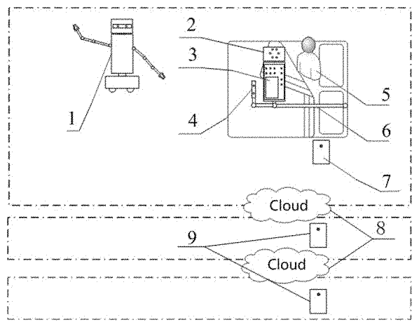

### TECHNICAL FIELD

The present disclosure relates to the field of mechanical control, and more particularly relates to a virtual reality-based caregiving machine control system.

### BACKGROUND

In recent years, the degree of population aging in our country increasingly deepens and the demand for companionship and care for the bedridden elderly increasingly grows. In addition, the number of patients with physical injuries caused by car accidents and other accidents also increases rapidly, and the society and families need to treat and accompany these patients at great cost, which brings a heavy burden to the families and the society. In order to meet the basic life needs of the bedridden elderly and patients and to improve the quality of life, intelligent caregiving robots have become a hot research topic nowadays.

Because the working environment of the caregiving robot is relatively complicated and there are uncertainties in the operation objects and methods, interactions between the robot and people and between the robot and the environment are complicated, or even dangerous, easily causing harms to the user and the environment. With the development of the technology, a single way of interaction can no longer meet the needs of people.

In the prior art, the independent intelligent algorithms, such as autonomous navigation, object recognition, and object grabbing, of the caregiving robot are not mature, making it difficult to well implement natural, safe, and effective interactions between the robot and people and between the robot and the environment, and difficult to realize diverse and complex caregiving demands such as detailed exploration of unknown and changing local areas in the home environment and grabbing unidentified objects.

### SUMMARY

Invention objective: The present disclosure aims to provide a virtual reality-based caregiving machine control system.

### Technical Solution

An embodiment of the present disclosure provides a virtual reality-based caregiving machine control system, which includes: a touch display screen, a visual unit, a virtual scene generation unit, and a calculation unit, where:

the visual unit is configured to obtain environmental information around a caregiving machine, and transmitting the environmental information to the virtual scene generation unit and the calculation unit;
the calculation unit is configured to receive control instructions for the caregiving machine, and obtaining, by calculation according to the environmental information, an action sequence of executing the control instructions by the caregiving machine, where the control instructions are configured to control the caregiving machine to execute a caregiving purpose;
the virtual scene generation unit is configured to generate a virtual reality scene from the environmental information, and display the virtual reality scene on the touch display screen in combination with the action sequence; and
the touch display screen is configured to receive a touch screen adjusting instruction for the action sequence and feeding back same to the calculation unit for execution; and after receive a confirmation instruction for the action sequence, control, by the calculation unit according to the action sequence, the caregiving machine to execute the control instructions.

Specifically, the system further includes a voice unit, configured to receive a voice adjustment instruction for the action sequence; and after receiving a confirmation instruction for the action sequence, controlling, by the calculation unit according to the action sequence, the caregiving machine to execute the control instructions.

Specifically, the calculation unit is further configured to divide the action sequence into steps according to the environmental information and displaying the steps on the touch display screen, and receiving the touch screen adjusting instruction and/or the voice adjustment instruction for the steps in the action sequence and feeding same to the calculation unit for execution.

Specifically, the calculation unit further includes a training and learning model, configured to perform training and learning by using an adjusted and confirmed action sequence as a sample after the calculation unit obtains, by calculation according to the environmental information, an action sequence of executing rehearsal instructions by the caregiving machine, where the rehearsal instructions are configured to control the caregiving machine to rehearse the execution of the caregiving purpose.

Specifically, the training and learning model is further configured to perform training and learning by using the action sequence actually executed by the caregiving machine as a sample.

Specifically, the training and learning model is further configured to obtain, by calculation according to the environmental information, an action sequence of executing the control instructions by the caregiving machine.

Specifically, the system further includes a cloud server, which is configured to collecting the confirmed action sequence and a corresponding execution result from the calculation unit, and is in a shared state with the caregiving machine control system communicatively connected thereto.

Specifically, the cloud server sends the environmental information and training instructions to the virtual scene generation unit and the calculation unit; the calculation unit obtains, by calculation according to the environmental information, an action sequence of executing the training instructions by the caregiving machine; then, the training and learning model performs training and learning by using the adjusted and confirmed action sequence as a sample; and finally, the cloud sever sends the adjusted and confirmed action sequence to an original caregiving machine control system as a sample.

### Beneficial Effects

Compared to the prior art, the present disclosure has the following obvious advantages: The human-machine interaction can be increased, natural and effective interactions between the caregiving machine and a person and between the caregiving machine and the environment can be implemented, the probability of an unknown error can be avoided, and the probability of causing harms to the user and the environment can be reduced, thus reflecting the dominance of the bedridden user.

Further, a successfully adjusted solution, the virtual environment of the bedridden user, and a caregiving target solution are shared in the cloud, so that a platform for recreation, training, and mutual help is provided for the bedridden user and learning data is provided for the cloud-connected caregiving machine control system, thus facilitating rapid improvement of the service capability of the caregiving machine control system.

### BRIEF DESCRIPTION OF THE DRAWINGS

The FIGURE is a schematic structural diagram of a virtual reality-based caregiving machine control system provided in an embodiment of the present disclosure.

### MEANINGS OF NUMERALS

1. Caregiving machine; 2. Voice unit; 3. Touch display screen; 4. Visual unit; 5. User; 6. Movable support frame; 7. Calculation unit; 8. Cloud server; 9. Caregiving machine control system connected to the cloud server

### DETAILED DESCRIPTION OF THE EMBODIMENTS

The technical solution of the present disclosure is further described below with reference to the accompanying drawing.

Refer to the FIGURE, which is a schematic structural diagram of a virtual reality-based caregiving machine control system provided in an embodiment of the present disclosure, and shows a specific structure. Detailed description is made below with reference to the accompanying drawing.

The embodiment of the present disclosure provides a virtual reality-based caregiving machine control system, which includes: a touch display screen, a visual unit 4, a virtual scene generation unit, and a calculation unit 7.

The visual unit 4 is configured to obtain environmental information around a caregiving machine 1, and transmitting the environmental information to the virtual scene generation unit and the calculation unit 7.

The calculation unit 7 is configured to receive control instructions for the caregiving machine, and obtaining, by calculation according to the environmental information, an action sequence of executing the control instructions by the caregiving machine, where the control instructions are configured to control the caregiving machine 1 to execute a caregiving purpose and are received via the touch display screen 3.

The virtual scene generation unit is configured to generate a virtual reality scene from the environmental information, and display the virtual reality scene on the touch display screen 3 in combination with the action sequence.

The touch display screen 3 is configured to receive a touch screen adjusting instruction for the action sequence and feeding back same to the calculation unit 7 for execution; and after receiving a touch screen confirmation instruction for the action sequence, control, by the calculation unit 7 according to the action sequence, the caregiving machine 1 to execute the control instructions.

In a specific implementation, the visual unit 4 may include an image acquisition device, for example, a video camera, a camera, or a depth camera, which can be configured to acquire information about the surrounding environment, namely, the surrounding environment images, geography, and placement positions of various objects and their positional relationship between each other, etc.; and transmit the environmental information to the virtual scene generation unit and the calculation unit 7 that are connected thereto.

In a specific implementation, after generating the virtual reality scene from the environmental information, the virtual scene generation unit can display the virtual reality scene separately on the touch display screen 3. During execution of the control instructions, the virtual reality scene may be displayed on the touch display screen 3 in combination with the action sequence after generation of the action sequence. That is, the execution of the action sequence by the caregiving machine 1 to complete the control instructions is shown in the virtual reality scene displayed on the touch display screen 3.

In a specific implementation, the control instructions may be input by a user 5 through the touch display screen 3, or may also be input in other manners, such as voice. The control instructions generally indicate results obtained after the user 5 expects the caregiving machine 1 to execute actions, for example, grabbing an object placed somewhere, moving an object somewhere, picking up an object and delivering it to the user 5, and the like.

In a specific implementation, the calculation unit 7 is connected to the touch display screen 3 and can receive instructions transmitted from the touch display screen 3. After receiving the control instructions, the calculation unit performs calculation and obtains an action sequence of completing the control instructions, and displays the action sequence on the touch display screen 3. The user 5 can watch the virtual execution of the control instructions by the caregiving machine 1 on the touch display screen 3.

In a specific implementation, generally, the independent algorithm of the calculation unit 7 is not mature enough, and the action sequence obtained after calculation is usually not perfect and reasonable, making it difficult to well implement natural, safe, and effective interactions between the robot and people and between the robot and the environment, and difficult to realize diverse and complex caregiving demands such as detailed exploration of unknown and changing local areas in the home environment and grasping unidentified objects. Therefore, when required, the user 5 can input an adjusting instruction through the touch display screen 3 to adjust the action sequence executed by the caregiving machine 1 in the virtual reality scene displayed on the touch display screen 3, so as to achieve an execution effect expected by the user 5, increase human-machine interaction, implement natural and effective interactions between the caregiving machine 1 and a person and between the caregiving machine 1 and the environment, avoid the probability of an unknown error, and reduce the probability of the caregiving machine 1 causing harms to the user 5 and the environment, thus reflecting the dominance of the bedridden user 5.

In a specific implementation, the touch display screen 3 may be supported by a movable support frame 6. There are parameters such as a navigation path line, the speed, and a grabbing position and strength of the caregiving machine 1 in the virtual execution of the control instructions by the caregiving machine 1 that is displayed on the touch display screen 3. The adjusting instruction usually indicates adjusting, by user 5, the displayed parameters such as the navigation path line, the speed, and the grabbing position and strength, including, for example, adjusting the movement path and speed of the caregiving machine 1; the path and movement speed, and the position and strength of a robot arm grabbing the object; and the like.

In a specific implementation, after the user 5 inputs the adjusting instruction, the computer performs calculation and obtains a status of the caregiving machine 1 executing an adjusted action sequence based on the adjusting instruction, and displays the status on the touch display screen 3. When appropriate, the user 5 may input a confirmation instruction, and then the calculation unit 7 controls the caregiving machine 1 to execute the adjusted action sequence.

In a specific implementation, the confirmation instruction may be input through the touch display screen 3, or may also be input by means of voice, a button, and the like.

In the embodiment of the present disclosure, the caregiving machine control system may further include a voice unit 2, which is configured to receive a voice adjustment instruction for the action sequence; and after receiving a confirmation instruction for the action sequence, controlling, by the calculation unit 7 according to the action sequence, the caregiving machine 1 to execute the control instructions.

In a specific implementation, the touch display screen 3 may display that a specific voice instruction has a corresponding adjustment effect on the action sequence. For example, the display of “to the left” means to shift the path of the caregiving machine 1 to the left, the display of “lower” means to lower the position of the caregiving machine 1 grabbing an object. Alternatively, the action sequence may be adjusted by parsing the voice meaning. The arrangement of the voice unit 2 further facilitates and deepens the human-machine interaction between a physically impaired user 5 and the machine, avoids the probability of an unknown error, and reduces the probability of the caregiving machine 1 causing harms to the user 5 and the environment, thus reflecting the dominance of the bedridden user 5.

In a specific implementation, the voice unit 2 may be composed of a microphone array and a development board, and can be configured to receive other instructions, such as the control instructions and the confirmation instruction, from the user 5.

In the embodiment of the present disclosure, the calculation unit 7 is further configured to divide the action sequence into steps according to the environmental information, and receive the touch screen adjusting instruction and/or the voice adjustment instruction for the steps in the action sequence and feeding same to the calculation unit 7 for execution.

In a specific implementation, the calculation unit 7 may divide the action sequence into multiple steps according to the environmental information. For example, the process of bypassing an obstacle is a separate step, the process of grabbing an object is a separate step, and the like. The division of the action sequence into multiple steps can greatly facilitate adjustment by the user 5, and moreover can avoid other actions that the user 5 does not want to make adjustments from being adjusted during adjustment of the action sequence, thus improving the effectiveness of human-machine interaction and compensating for the inadequacies of the computer algorithm.

In the embodiment of the present disclosure, the calculation unit 7 further includes a training and learning model, which is configured to perform training and learning by using an adjusted and confirmed action sequence as a sample after the calculation unit 7 obtains, by calculation according to the environmental information, an action sequence of executing rehearsal instructions by the caregiving machine 1, where the rehearsal instructions are configured to control the caregiving machine 1 to rehearse the execution of the caregiving purpose.

In the embodiment of the present disclosure, the training and learning model is further configured to perform training and learning by using the action sequence actually executed by the caregiving machine 1 as a sample.

In the embodiment of the present disclosure, the training and learning model is further configured to obtain, by calculation according to the environmental information, an action sequence of executing the control instructions by the caregiving machine 1.

In a specific implementation, the rehearsal instructions are instructions of rehearsing the control instructions.

In a specific implementation, a rehearsal mode may be conducted when the user 5 has not issued the control instructions. That is, the execution of the rehearsal instructions by the caregiving machine 1 is virtually rehearsed in the touch display screen 3, and the user 5 can adjust the corresponding action sequence. After confirming the action sequence, the user 5 can train the training and learning model by using the confirmed action sequence as a sample. Definitely, the action sequence of actually executing the control instructions can also be used as a sample for training and learning. After repeated learning and training by the training and learning model of the calculation unit 7, the rationality of the action sequence obtained after calculation by the calculation unit 7 according to the environmental information can be improved, and it is convenient for the user 5 to use the caregiving machine 1 subsequently, thus facilitating rapid improvement of the service capability of the caregiving machine control system. Moreover, the dominance of the bedridden user 5 can be reflected, thus improving the enthusiasm for life of the bedridden user 5.

In the embodiment of the present disclosure, the system further includes a cloud server 8, which is configured to collect the confirmed action sequence and a corresponding execution result from the calculation unit 7, and is in a shared state with the caregiving machine control system 9 communicatively connected thereto.

In a specific implementation, the cloud server 8 can store the collected confirmed action sequence and corresponding execution result as a historical record, and can share the record with the caregiving machine control system 9 communicatively connected to the cloud server 8. After the caregiving machine control system 9 uploads the environmental information and the corresponding control instructions to the cloud server 8, the cloud server 8 can feed back a solution of an action sequence successfully adjusted by other users 5 from the stored historical record. Alternatively, after training and learning the historical record, the training and learning model of the cloud server 8 can perform calculation for the uploaded environmental information and corresponding control instructions, and feeds back an action sequence obtained after calculation, thus facilitating rapid improvement of the service capability of the caregiving machine control system.

In the embodiment of the present disclosure, the cloud server 8 sends the environmental information and training instructions to the virtual scene generation unit and the calculation unit 7; the calculation unit 7 obtains, by calculation according to the environmental information, an action sequence of executing the training instructions by the caregiving machine; then, the training and learning model performs training and learning by using the adjusted and confirmed action sequence as a sample; and finally, the cloud sever 8 sends the adjusted and confirmed action sequence to an original caregiving machine control system as a sample.

In a specific implementation, with the consent of other bedridden users (corresponding to the original caregiving control system), the cloud server 8 can upload, on the original caregiving control system, environmental information and its corresponding training instructions (which include rehearsal instructions and control instructions) of the original caregiving control system. The cloud server 8 shares the environmental information and the training instructions with the current caregiving machine control system and the original caregiving control system. Therefore, the current caregiving machine control system conducts a rehearsal mode according to the environmental information and the training instructions, that is, execution of the training instructions by the caregiving machine 1 is virtually rehearsed in the touch display screen 3; and the user 5 can adjust the corresponding action sequence. After confirming the action sequence, the user 5 can train the training and learning model by using the confirmed action sequence as a sample, and further the cloud server 8 sends the adjusted and confirmed action sequence to the original caregiving machine control system as a sample, for learning and training by the original caregiving machine control system.

What is claimed is:

1. A virtual reality-based caregiving machine control system, comprising a touch display screen, a visual unit, a virtual scene generation unit, and a calculation unit, wherein the visual unit is configured to obtain environmental information around a caregiving machine, and transmit the environmental information to the virtual scene generation unit and the calculation unit;
the virtual scene generation unit is configured to generate a virtual reality scene from the environmental information, and display the virtual reality scene on the touch display screen in combination with the action sequence;
the calculation unit is configured to receive control instructions for the caregiving machine, and obtain, by calculation according to the environmental information, an action sequence of executing the control instructions by the caregiving machine, wherein the control instructions are configured to control the caregiving machine to execute a caregiving purpose; and
the touch display screen is configured to receive a touch screen adjusting instruction for the action sequence and feeding back same to the calculation unit for execution; and after receive a confirmation instruction for the action sequence, control, by the calculation unit according to the action sequence, the caregiving machine to execute the control instructions.

2. The virtual reality-based caregiving machine control system according to claim 1, further comprising a voice unit, configured to receive a voice adjustment instruction for the action sequence; and after receive a confirmation instruction for the action sequence, control, by the calculation unit according to the action sequence, the caregiving machine to execute the control instructions.

3. The virtual reality-based caregiving machine control system according to claim 2, wherein the calculation unit is further configured to divide the action sequence into steps according to the environmental information and displaying the steps on the touch display screen, and receive the touch screen adjusting instruction and/or the voice adjustment instruction for the steps in the action sequence and feeding same to the calculation unit for execution.

4. The virtual reality-based caregiving machine control system according to claim 3, wherein the calculation unit further includes a training and learning model, configured to perform training and learning by using an adjusted and confirmed action sequence as a sample after the calculation unit obtains, by calculation according to the environmental information, an action sequence of executing rehearsal instructions by the caregiving machine, wherein the rehearsal instructions are configured to control the caregiving machine to rehearse the execution of the caregiving purpose.

5. The virtual reality-based caregiving machine control system according to claim 4, wherein the training and learning model is further configured to perform training and learning by using the action sequence actually executed by the caregiving machine as a sample.

6. The virtual reality-based caregiving machine control system according to claim 5, the training and learning model is further configured to obtain, by calculation according to the environmental information, an action sequence of executing the control instructions by the caregiving machine.

7. The virtual reality-based caregiving machine control system according to claim 5, further comprising a cloud server, which is configured to collect the confirmed action sequence and a corresponding execution result from the calculation unit, and is in a shared state with the caregiving machine control system communicatively connected thereto.

8. The virtual reality-based caregiving machine control system according to claim 7, wherein the cloud server sends the environmental information and training instructions to the virtual scene generation unit and the calculation unit; the calculation unit obtains, by calculation according to the environmental information, an action sequence of executing the training instructions by the caregiving machine; then, the training and learning model performs training and learning by using the adjusted and confirmed action sequence as a sample; and finally, the cloud sever sends the adjusted and confirmed action sequence to an original caregiving machine control system as a sample.
